(19) United States
(12) Patent Application Publication
(10) Pub. No.: US 2012/0189909 A1
(43) Pub. Date: Jul. 26, 2012

(54) GALVANIC CELL

(75) Inventors: Claus-Rupert Hohenthanner, Hanau (DE); Claudia Brasse, Meerbusch (DE); Torsten Schmidt, Landsberg (DE); Heike Schoene, Elstra (DE); Jens Meintschel, Bernsdorf (DE)

(73) Assignee: LI-TEC BATTERY GMBH, Kamenz (DE)

(21) Appl. No.: 13/384,930

(22) PCT Filed: Jul. 20, 2010
(86) PCT No.: PCT/EP10/04438

§ 371 Date: Apr. 5, 2012

(30) Foreign Application Priority Data
Jul. 20, 2009 (DE) 10 2009 033 932.9

(51) Int. Cl. H01M 2/02; H01M 2/10

(52) U.S. Cl. 429/186

(57) ABSTRACT

According to the invention, electric arresters (302, 303, 402, 403) with opposite electric polarity extend from a housing of a galvanic cell (301, 401) at several points for dissipating energy stored in the galvanic cell. At other points, the housing comprises a design (304, 305, 306, 307) supporting the space-saving fastening of the storage cell or a space-saving arrangement of fastening elements (408, 409, 410, 411) for fastening the storage cell within an installation

The invention relates to a galvanic cell. Such galvanic cells are required and used for different applications in various areas of technology. In most applications of galvanic cells, the objectives are, inter alia, to maximize the space-related energy density, that is, the stored energy relative to the volume of the galvanic cell. Such cells are suitable for building batteries comprising a plurality of such cells, and therefore such cells are occasionally also referred to as battery cells.

Galvanic cells that are flat and rectangular are known, the electrochemically active part of which is surrounded by a film-like packaging through which electric connections in sheet metal form (“current collectors”) are guided. Battery cells having such a design are often referred to as pouch cells or coffee bag cells. The electric voltage is often tapped by way of contact elements connected to the sheet-metal connections in a form-fit, non-positive or bonded manner. They can be connected to the current collectors on one side or both sides. The contact elements are connected directly or indirectly to the electric current consumers or current sources in the case of individual cells, or serve to connect the cells electrically in series or in parallel in the case of batteries or cell blocks.

A few known solutions for fastening the cells in a support structure come in contact only with the current collectors. Others enclose the cell edge in part or in entirety. In a few applications, the first possibility is associated with the disadvantage that additional installation space is obtained by extending retaining elements, in part or in entirety, past the cell in the radial direction. In a few applications, the second possibility is associated with the disadvantage that the entire structure has low load-carrying capacity. In addition, the risk of leaks forming in the cells can be increased by tensile/shear stress on a current collector passage.

The problem addressed by the present invention is that of making a contribution to the maximization of the space-related energy efficiency of installations of such galvanic cells. This problem is solved by a galvanic cell according to claim 1.

In this galvanic cell according to the invention, comprising a housing and at least two electric current collectors having opposite electric polarity for delivering the energy stored in the galvanic cell, which protrude out of the housing at a few first points, the housing has a design having particular design elements at another second point or other second points at which current collectors do not protrude out of the housing of the galvanic cell, which supports a space-saving fastening of the storage cell or a space-saving arrangement of fastening elements for fastening the storage cell within an installation with the aid of these particular design elements.

A galvanic cell in the sense of the present invention refers to electric cells of any type, in particular electrochemical cells, and, in the case of the latter, primary or secondary cells in particular. At least two contact elements or electrodes, which are commonly referred to by a person skilled in the art as current collectors or sheet-metal connections, which serve to deliver the energy stored in the galvanic cell, are guided outwardly out of the housing of such galvanic cells. These current collectors often protrude out of the housing at only a few points. According to the invention, the housing of a cell according to the invention is designed such that the points of the housing that are not required or used to route the current collectors outwardly support a space-saving arrangement of fastening elements for fastening the storage cell within an installation.

They can be one or more points on the edge of the housing that are selected such that they support a space-saving arrangement of a fastening element or a plurality of fastening elements.

In many cases, this housing is substantially flat and rectangular. The electrically or electrochemically active part of such cells is often surrounded by a film-like packaging.

Regardless of the shape of the housing, this packaging is a component of the housing of the cell within the scope of the present invention.

In this context, a space-saving arrangement is understood to mean any arrangement which contributes to the maximization of the energy content relative to the volume effectively required for the storage thereof in the installation. The effectively required volume is the partial volume of the installation, which cannot be used in any other manner, to be allocated to the particular cell. It includes the volume of the galvanic cell and the sum of the volumes of all “dead spaces” of this galvanic cell. The effectively required volume is therefore dependent not only upon the volume of the galvanic cell itself, but also on the installation technology and the type and arrangement of the fastening means used for installation.

In the context of the invention, a fastening element is understood to be any device which is suitable for fastening the cell in the installation, i.e. to limiting the freedom of motion thereof even partially, if necessary.

In the context of the present invention, a design which supports space-saving fastening of the storage cell or a space-saving arrangement of fastening elements for fastening the storage cell within an installation is intended to mean any design of the housing, including the packaging thereof, if available, which contributes to the maximization of the energy content relative to the volume effectively required for the storage thereof in the installation.

Advantageous developments of the invention are the subject matter of dependent claims. The invention is described in greater detail in the following with reference to preferred embodiments and with the aid of figures.

They show:

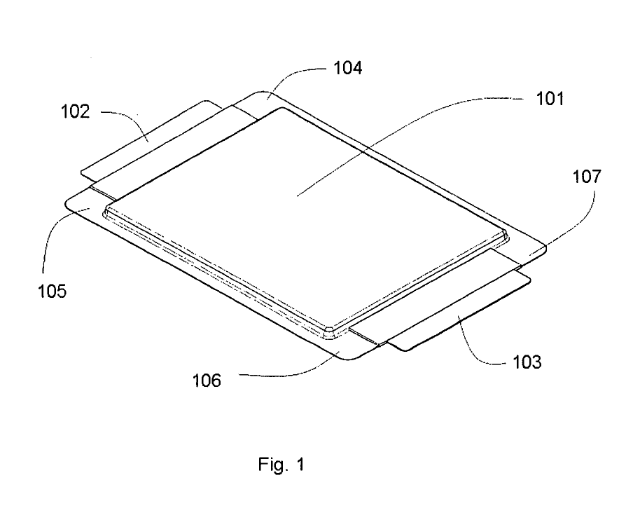

FIG. 1 a typical galvanic cell using the example of a flat, rectangular “pouch cell”;

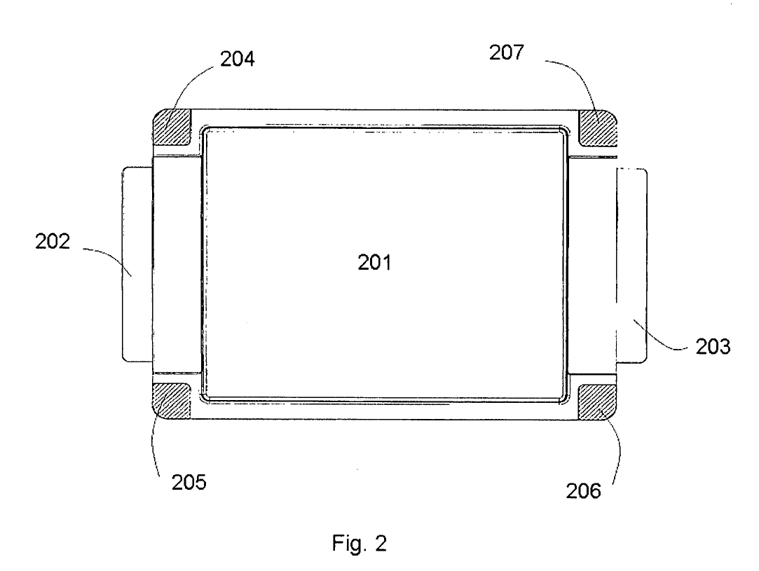

FIG. 2 a pouch cell as in FIG. 1, comprising housing points depicted with particular emphasis, which can be used for guiding sheet-metal connections to the outside and fastening the cell;

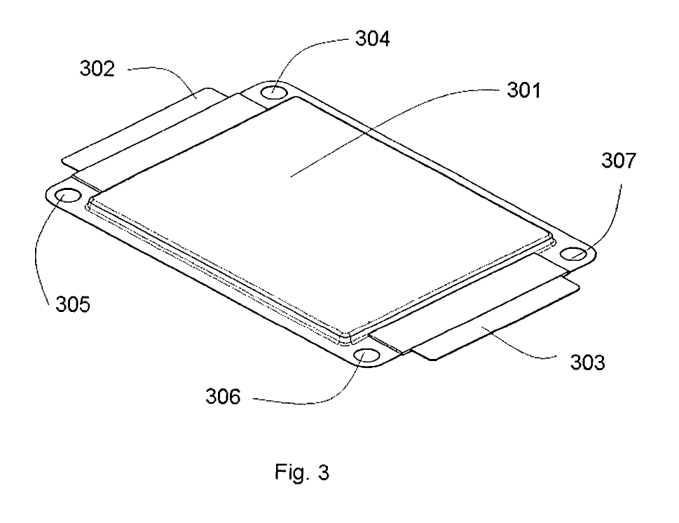

FIG. 3 a galvanic cell comprising cutouts in the housing, according to a preferred embodiment of the present invention;

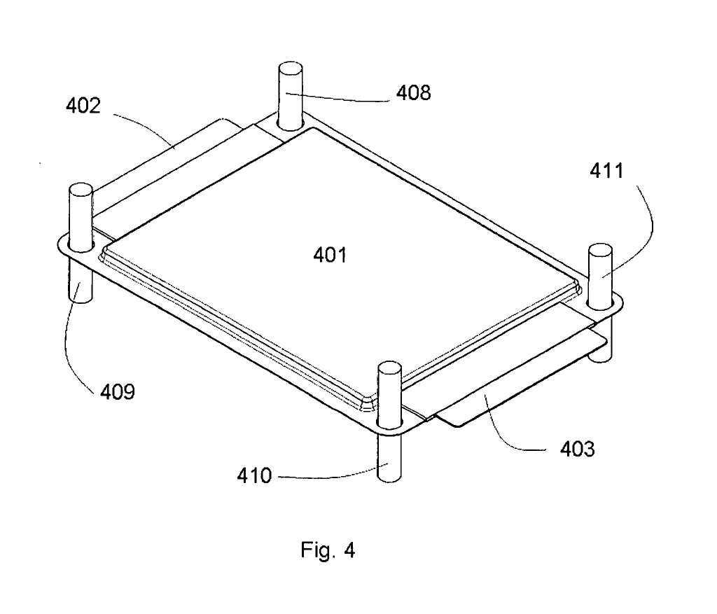

FIG. 4 a galvanic cell comprising cutouts in the housing and fastening elements guided through these cutouts, according to a preferred embodiment of the present invention;

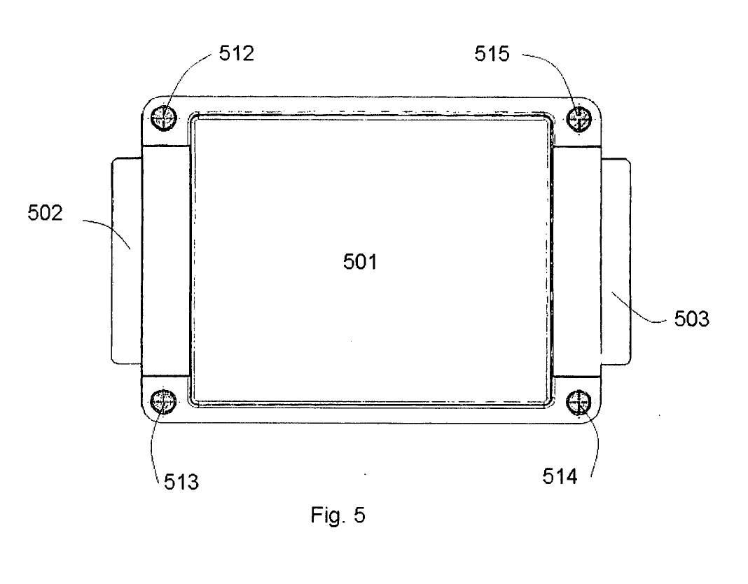

FIG. 5 a top view of the arrangement shown in FIG. 4.

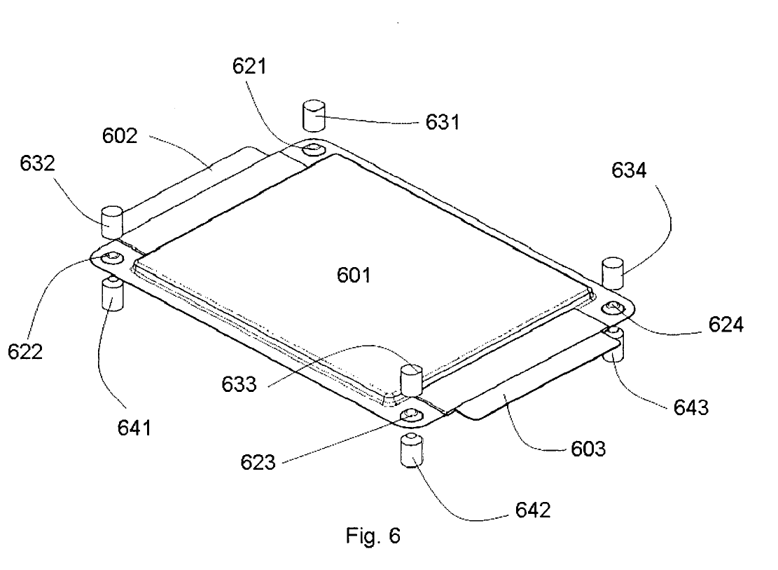

FIG. 6 a pouch cell comprising impressions in the packaging, by way of which the cell is clamped into the retaining elements, according to a preferred embodiment of the present invention.

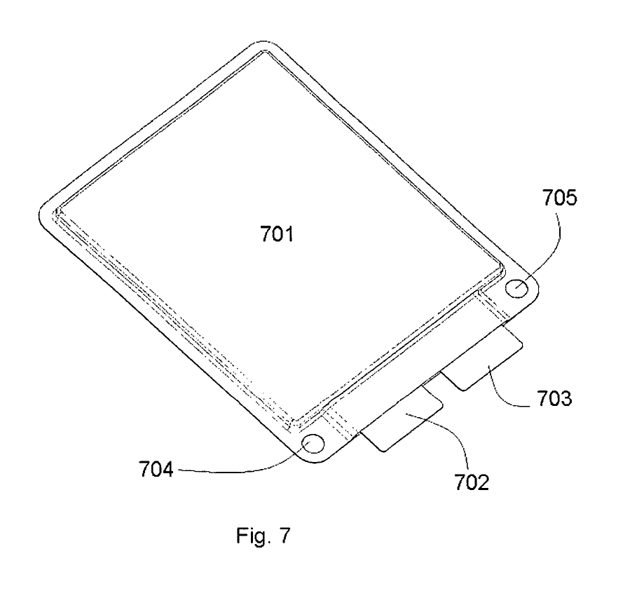

FIG. 7 a storage cell comprising current collectors which are guided outwardly on the same housing side, and comprising cutouts at other points of the housing, according to a preferred embodiment of the present invention.

As depicted in FIG. 1, galvanic cells often have a flat, substantially rectangular shape. This shape simplifies the assembly of a plurality of such galvanic cells to form batteries, in which such galvanic cells are electrically interconnected in series or in parallel. Although the invention is described using such “pouch cells” by way of example, it is not limited to such cells.

In such cells 101, the electrically or electrochemically effective part of these cells is typically surrounded by a film-like packaging which is welded, bonded or joined in any other manner at the edge of the cell 104, 105, 106, 107, and between the layers of which the sheet-metal connections 102, 103 are guided to the outside to permit electric contacting thereof to connections of an installation. The film-like packaging enlarges the smallest enclosing rectangle in which the galvanic cell could be accommodated. As a result, the volume which is required for installing the galvanic cell in an installation, and which is otherwise unusable, is also increased.

The invention is based on the finding that the losses in energy efficiency of the installation, which, in part, are unavoidably associated therewith, can be reduced if these portions of the volume can indeed be made useful. As shown in FIG. 2, the housing of the storage cell shown in FIG. 1 as an example comprises points 204, 205, 206, 207 (which are also referred to by a person skilled in the art as “dead spaces”) which remain unused if they are not used to fasten the cell. This finding is utilized by the present invention.

These dead spaces are located at different points than the current collectors 202, 203 of the cell 201. Often, although not necessarily, they are located at the corners of the housing or the galvanic cell. FIG. 3 shows how the invention utilizes these dead spaces, by reference to an embodiment of the invention. In this embodiment, cutouts such as holes 304, 305, 306, 307 are provided at the corners of the packaging of the galvanic cell, through which the fastening elements 408, 409, 410, 411, 512, 513, 514, 515 can be guided to fasten the storage cell in an installation, as shown in FIGS. 4 and 5.

An embodiment of the invention is advantageous and, therefore, preferable, in which at least one contact element is disposed on one side of at least one current collector, and at least one insulation or retaining element (which, inter alia, can press the current collectors against the contact element) is disposed on the other side.

Expressed more generally, according to the present invention, the dead spaces resulting from the fact that the current collectors do not require the entire length of a side edge of the rectanglar cell (see FIG. 2) are used to arrange fastening elements in a manner that is neutral with regard to installation space. To this end, the cell (or the packaging) is equipped in these regions with cutouts, for example, i.e. holes, etc., with recesses, such as notched or folded corners, targeted reshapings, such as embossings, etc., or with parts placed thereon, such as nubs glued thereon, etc., into which the correspondingly shaped retaining elements can engage.

An embodiment comprising such embossings in the packaging of the cell is shown in FIG. 6. The corners 204, 205, 206, 207 of the packaging of the storage cell (see FIG. 2) comprise nub-shaped structures 621, 622, 623, 624 in this case, which can be applied e.g. by way of a corresponding embossing of the film or by bonding thereon. Correspondingly shaped fastening elements 631, 632, 633, 634, 641, 642, 643 can now engage into these structures which are nub-like, for example.

The sheet-metal connections of a galvanic cell (also referred to as a storage cell) do not always need to be applied to opposite sides of the housing. As shown in FIG. 7, a particularly large amount of installation space can be saved in some cases by arranging the sheet-metal connections on one side because the housing edge on the opposite side—i.e., the width of the foil strip on the side opposite the sheet-metal connections in the case shown—can be designed particularly narrow. In such cases it is often particularly advantageous to apply the shaping elements of the housing, which are provided according to the invention, i.e. the recesses, cutouts or structures placed thereon, for example, as shown in FIG. 7, on the side on which the sheet-metal connections are also disposed.

1.-5. (canceled)

6. A galvanic cell (101, 201, 301, 401, 501, 601, 701) comprising a housing and at least two electric current collectors (102, 103, 201, 203, 302, 303, 402, 403, 502, 503, 602, 603, 702, 703) having opposite polarity for delivering the energy stored in the galvanic cell, which protrude out of the housing at some first points, wherein at another second point or other second points at which current collectors do not protrude out of the housing of the galvanic cells, the housing has a design (304, 305, 306, 307, 621, 622, 623, 624) comprising design elements, which supports a space-saving fastening of the storage cell or a space-saving arrangement of fastening elements (408, 409, 410, 411, 631, 632, 633, 634, 641, 642, 643) for fastening the storage cell within an installation with the aid of these design elements, wherein:
a) the housing comprises a film-like packaging which is welded, bonded or joined in any other manner at the edge of the cell (104, 105, 106, 107),
b) this edge of the film-like packaging comprises at least one structure (621, 622, 623, 624), as a design element, embossed in the film,
c) correspondingly shaped fastening elements (631, 632, 633, 634, 641, 642, 643) or retaining elements can engage in these design elements which are embossed in the manner of nubs.

7. The galvanic cell according to claim 6, the housing of which is equipped with at least one cutout (304, 305, 306, 307, 704, 705) at at least one second point, through which fastening elements (408, 409, 410, 411, 512, 513, 514, 515) can be guided.

8. The galvanic cell according to claim 6, the housing of which is equipped with at least one shaped element (621, 622, 623, 624) at at least one second point, into which correspondingly shaped fastening elements (631, 632, 633, 634, 641, 642, 643) can engage.

9. The galvanic cell according to claim 6, the housing of which is provided with at least one cutout at least one second point, which supports a space-saving fastening of the storage cell or a space-saving arrangement of fastening elements for fastening the storage cell within an installation.

10. The galvanic cell according to claim 6, the housing of which is provided with at least one reshaping at least one second point, which supports a space-saving fastening of the storage cell or a space-saving arrangement of fastening elements for fastening the storage cell within an installation.
